(19) United States
(12) Patent Application Publication
(10) Pub. No.: US 2019/0373899 A1
(43) Pub. Date: Dec. 12, 2019

(54) Conveyor baking oven for continuous baking operation

(71) Applicant: Werner & Pfleiderer Industrielle Backtechnik GmbH, Tamm (DE)

(72) Inventors: Dieter Knost, Dinkelsbuhl (DE); Ulrich Speck, Ludwigsburg (DE)

(21) Appl. No.: 16/432,061

(22) Filed: Jun. 5, 2019

(30) Foreign Application Priority Data
Jun. 6, 2018 (DE) 10 2018 208 959.0

(51) Int. Cl. A21B 1/10; A21B 1/48; A21B 3/04; A21B 7/00; A21B 1/14

(52) U.S. Cl. CPC A21B 1/10; A21B 1/48; A21B 1/145; A21B 7/00; A21B 3/04

(57) ABSTRACT

A conveyor baking oven for continuous baking operation has at least two conveyor baking spaces. A plurality of oven modules of the baking oven have baking spaces, which combine to form the conveyor baking spaces between a respective initial oven module arranged in a leading manner when seen in the bakery product conveying direction, and a respective final oven module, which is the last in row when seen in the bakery product conveying direction. The oven modules have a multi-level arrangement such as to define the at least two conveyor baking spaces. A bakery product conveyor device is used to continuously convey bakery products through the conveyor baking spaces. A thermal oil heating device having at least one thermal oil heat exchanger is used to heat the conveyor baking spaces by radiant heat. The resulting conveyor baking oven is operable efficiently and adaptable to various throughput requirements.

### CROSS-REFERENCES TO RELATED APPLICATIONS

This application claims the priority of German patent application, Serial No. DE 10 2018 208 959.0, filed Jun. 6, 2018, pursuant to 35 U.S.C. 119(a)-(d), the content of which is incorporated herein by reference in its entirety as if fully set forth herein.

### TECHNICAL FIELD

The invention relates to a conveyor baking oven for continuous baking operation.

### BACKGROUND

A conveyor baking oven of this type is known from DE 1 095 223 A, from DE 26 29 716 A1, and from U.S. Pat. No. 1,832,374. Document DE 198 20 061 A1 describes a baking oven with a plurality of oven modules arranged one behind the other, each of said oven modules having a plurality of cookers arranged one above the other.

### SUMMARY

It is an object of the present invention to refine a conveyor baking oven of the type named at the outset in such a way as to be operable efficiently and adaptable to various throughput requirements.

This object is achieved by a conveyor baking oven for continuous baking operation, with at least two conveyor baking spaces, with a plurality of oven modules with baking spaces, which combine to form the conveyor baking spaces between a respective initial oven module arranged in a leading manner when seen in the bakery product conveying direction, and a respective final oven module, which is the last in row when seen in the bakery product conveying direction, wherein the oven modules have a multi-level arrangement such as to define the at least two conveyor baking spaces arranged on top of one another, with a bakery product conveyor device configured to continuously convey bakery products between the respective initial oven module and the respective final oven module of one of the conveyor baking spaces, with a thermal oil heating device having at least one thermal oil heat exchanger configured to heat the conveyor baking spaces by radiant heat.

It was found that a combination of a multi-level design, a modular design and a thermal oil heating results in a conveyor baking oven for continuous baking operation that offers particular advantages. Depending on the throughput requirements, it is conceivable to operate all conveyor baking spaces of the conveyor baking oven at once, or—alternatively—only selected conveyor baking spaces, or even only one conveyor baking space. The modular design allows the respective conveyor baking space to be flexibly adapted to respective throughput requirements, and, if necessary, to spatial requirements. A thermal oil heating device is operable in a particular energy-efficient manner. The conveyor baking spaces are heated by direct heat radiation emitted by the thermal oil heat exchangers. The thermal oil heat exchangers are directly associated to the respective conveyor baking space. An oven module of the conveyor baking oven may have a thermal oil heat exchanger to generate top heat and/or a thermal oil heat exchanger to generate bottom heat. The thermal oil heat exchangers can be configured as pipe heat exchangers.

A modular basic design of at least some of the oven modules is particularly cheap to produce.

A convection device configured to guide circulating air through the baking spaces in at least one circulating air cycle, with the at least one thermal oil heat exchanger being part of the at least one circulating air cycle, allows a heating of a baking space by radiant heat emitted by the thermal oil heat exchanger to be combined with the advantages of a convective heat transfer provided by the convection device. Depending on the design of the heat exchanger and depending on the control settings of the convection device, one of the two heat transfer mechanisms “heat radiation” or “heat release to circulating air” can be dominant. The convection device allows the air to be guided in circulation such that the air flows through at least one thermal oil heat exchanger associated to the respective baking space when being guided in circulation. In the respective baking space, the convection device causes the air to move, which—in addition to the radiant heat emitted by the thermal oil heat exchangers—results in an additional amount of energy transmitted to the product because of the convective heat transfer.

A design of some oven the modules each having at least two receptacles for in each case one fan configured to circulate the circulating air, with the respective baking space of the oven module being arranged between the receptacles, with the convection device having an arrangement of fans, used to circulate the circulating air, such that at least some of the baking oven modules are each equipped with at least one fan and of the convection device permits a design of the convection device that is flexibly adapted to baking requirements. The receptacles for the fans can be arranged in opposing side walls of the oven modules extending on the sides of the baking spaces along the bakery product conveying direction. It is not necessary to equip all oven modules with a fan of the convection device. It may be sufficient if, for example, only half or an even smaller number of the oven modules are provided with a fan.

A design of the convection device having an arrangement of the fans such that all of the oven modules of a conveyor baking space are equipped with at least one fan, allows a particularly flexible operation of the convection device. Depending on the baking requirements, it is conceivable to operate all or selected fans along the respective conveyor baking space in a pre-determined manner.

The fans can be operated in such a way that an airflow from bottom to top or from top to bottom is generated in the respective baking space.

An arrangement of the fans such that the fans are arranged on the same side of the baking spaces of the oven modules of one of the conveyor baking spaces offers advantages in terms of a supply and/or maintenance of the fans.

An alternating arrangement of the fans on one side and on the other side of the baking spaces of the oven modules of one of the conveyor baking spaces allows a uniformity of a baking result to be achieved over an entire width of the baking space.

Some or all of the oven modules can also be oriented such as to have two fans on both sides.

Depending on how the fans are being operated, it is possible, in the baking spaces arranged one behind the other in an oven module of one of the conveyor baking spaces, to provide a unidirectional flow direction through the baking spaces, in other words from bottom to top or from top to bottom, for example, or—alternatively—an alternating airflow, which may change directions once or several times from “from bottom to top” to “from top to bottom” when the bakery product is being conveyed through a conveyor baking space.

Exemplary embodiments of the invention will hereinafter be explained in more detail with reference to the drawing.

### BRIEF DESCRIPTION OF THE DRAWINGS

FIG. 1 shows a side view of a conveyor baking oven having a modular design;

FIG. 2 shows a schematic sectional view along line II-II in FIG. 1;

FIG. 3 shows a more detailed sectional view of two opposing fans of a baking oven module, having a convection device, of the conveyor baking oven, the section being made in a position similar to FIG. 2; and

FIGS. 4 to 7 show variations of arrangements of the fans of the convection device on the baking oven modules of a conveyor baking space of the conveyor baking oven as shown in FIG. 1.

### DETAILED DESCRIPTION

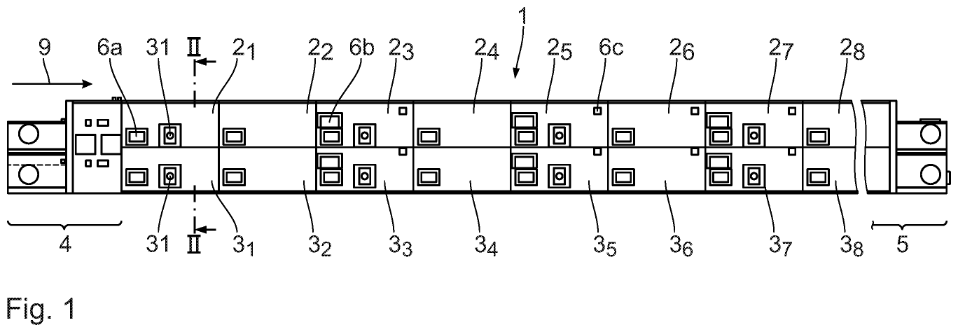

FIG. 1 shows a total side view of a conveyor baking oven 1 configured as a tunnel oven, which allows long-life bakery products such as soft biscuits, crispy biscuits or lye pastries to be produced. Other bakery products such as toast can also be processed in the baking oven. The baking oven 1 also allows roasting and special applications such as drying or sterilizing. In the embodiment shown, the baking oven 1 is shown in an interrupted view and has a plurality of oven modules 2ᵢ, 3ᵢ with baking spaces, which combine to form two conveyor baking spaces arranged on top of one another between a respective initial oven module 2₁, 3₁ arranged in a leading manner in a bakery product conveying direction and a respective final oven module 2_{N}, 3_{N}, which forms the last oven module in the bakery product conveying direction (i=1, . . . , N, N: number of oven modules). FIG. 1 shows a total of eight oven modules 2₁ to 2₈, which belong to an upper conveyor baking space, and eight oven modules 3₁ to 3₈ arranged therebelow, which belong to a lower conveyor baking space of the conveyor baking oven 1. In other words, the oven modules of the conveyor baking oven 1 are arranged on two levels.

The oven modules 2₁ to 2₈ and 3₁ to 3₈ each have the same basic design, in particular in terms of a support frame design and receptacles for attached and mounted parts. The oven modules 2₁ to 2₈ and 3₁ to 3₈ therefore have the same dimensions, in other words they generally have the same spatial requirements in terms of height, width and depth.

The oven modules 2₁ to 2₈ and 3₁ to 3₈ are provided as separate modules first, which are connected to each other when the baking oven 1 is being assembled. In each of the baking oven modules 2₁ to 2₈ and 3₁ to 3₈, heated circulating air is guided in circulation by heat exchangers, which will be described below. The upper oven modules 2₁ to 2₈ are carried by the lower oven modules 3₁ to 3₈. The lower oven modules 3₁ to 3₈ are carried by a machine base.

In front of an initial baking oven module 2₁ and 3₁ each arranged in a leading manner in the bakery product conveying direction, a loading module 4 for the bakery products is arranged, which also has a two-level design and communicates with the two conveyor baking spaces. Behind an final oven module 2ᵢ and 3ᵢ, which is the last one when seen in the bakery product conveying direction, a discharge module 5 of the conveyor baking oven 1 is arranged to receive and discharge the bakery product from the conveyor baking spaces after baking, the discharge module 5 having a two-level design as well and communicating with the two conveyor baking spaces. The loading module 4 on the one hand and the discharge module 5 on the other close the circulating air cycle at the beginning and at the end of the conveyor baking spaces.

Between the oven modules 2₈, 3₈ and the discharge module 5, the conveyor baking oven 1 is shown in an interrupted view in FIG. 1 to indicate that the number of oven modules 2ᵢ, 3ᵢ may be greater than that shown in FIG. 1. For example, the number N of the oven modules 2ᵢ, 3ᵢ may vary between 5 and 20 in practical application.

Bakery products to be baked enters, via the loading module 4, the respective conveyor baking space 7, 8, in other words the respective initial oven module 2₁, 3₁ arranged in a leading manner, passes through the respective conveyor baking space 7, 8 along the bakery product conveying direction 9 and, having passed through the respective final oven modules 2ᵢ, 3ᵢ,exits the conveyor baking spaces 7, 8 via the discharge module 5 as a freshly baked product.

In the side view of the conveyor baking oven as shown in FIG. 1, some or all of the oven modules 2i, 3i are further provided with in each case one cleaning opening 6a, in each case one inspection opening 6b, and in each case one fume opening 6c. The respective fume opening 6c allows fumes to be introduced into and removed from the respective baking space of the oven module 2ᵢ, 3ᵢ .

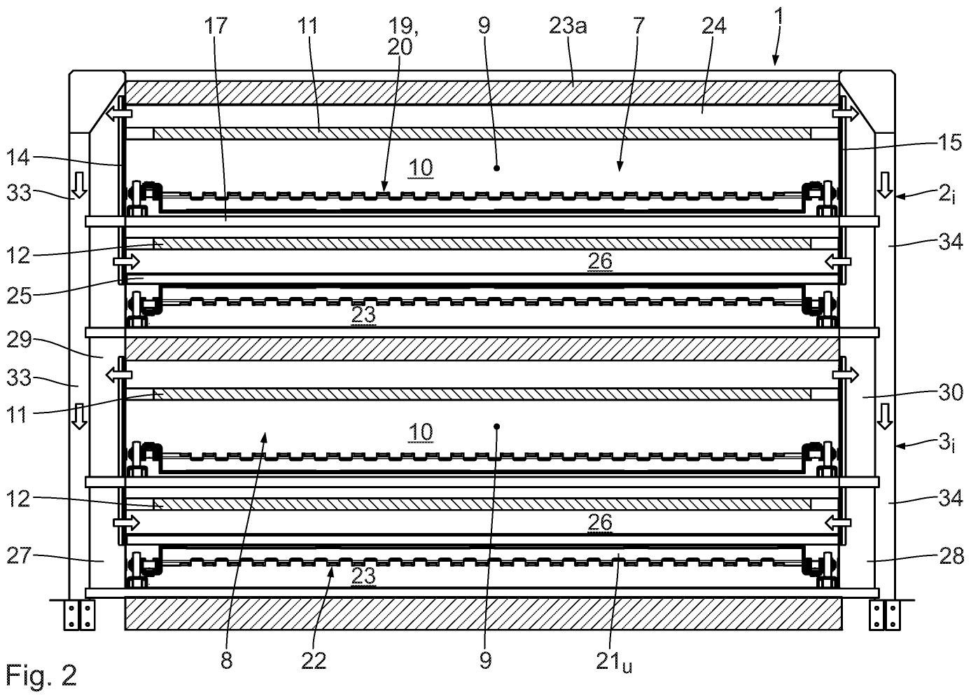

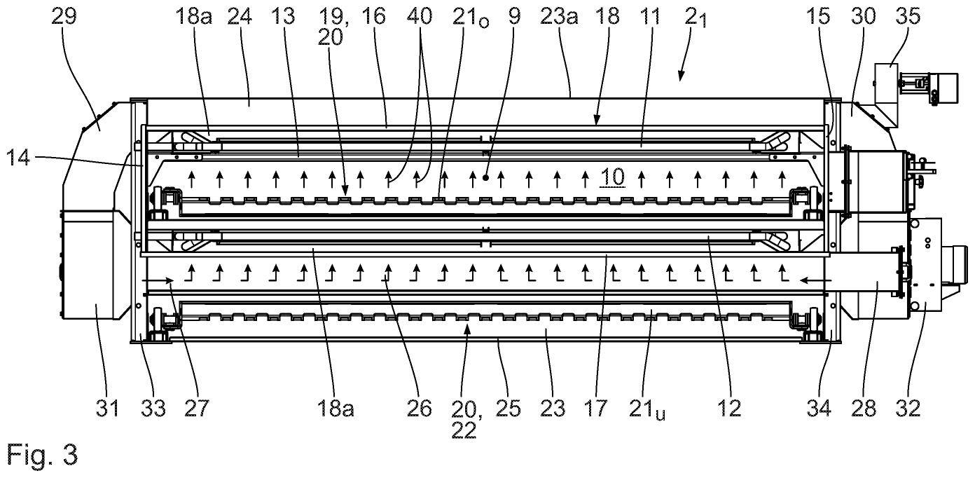

FIG. 2 shows a sectional view of two baking oven modules 2ᵢ, 3ᵢ arranged on top of one another. The conveying direction 9 is perpendicular to the sectional or drawing plane of FIG. 2. FIG. 3 shows an exemplary and more detailed view of one of the oven modules 2ᵢ. The oven modules 3ᵢ have the same design so it is sufficient to show, in the detailed illustration of FIG. 3, only one of the oven modules 2ᵢ to serve as example. Details not shown in FIG. 2 can then be found in FIG. 3.

The baking oven modules 2ᵢ, 3ᵢ each have a baking space 10, which is heated, on the one hand, directly by the circulating air, and, on the other hand, by radiant heat, which is generated by heat exchangers configured as two pipe coil heat exchangers 11, 12. The baking spaces 10 each form part of the two conveyor baking spaces 7, 8 arranged on top of one another, which are formed by the upper oven modules 2ᵢ on the one hand and by the lower oven modules 3ᵢ on the other. The pipe heat exchanger 11 arranged above the respective baking space 10 generates top heat for the baking space 10. The pipe heat exchanger 12 arranged below the baking space generates bottom heat for the baking space 10.

The heat carrier fluid flowing through the pipe heat exchangers 11, 12 is thermal oil.

Together with a thermal oil source not shown, the two heat exchangers 11, 12 form a thermal oil heating device.

The upper pipe heat exchanger 11 is carried by a retaining frame 13 mounted to lateral frame sidewalls 14, 15 of the baking oven module 2ᵢ, 3ᵢ. Together with an upper retaining plate 16 and a lower retaining plate 17, the two frame sidewalls 14, 15 form a baking oven module 18, which houses—amongst other things—the two pipe heat exchangers 11, 12 of the baking oven module 2ᵢ, 3ᵢ. Between the upper retaining plate 16 and the upper pipe heat exchanger 11, an air baffle 18a is arranged. Said air baffle 18a serves to ensure a uniformity of a circulating airflow in the baking space 10. The air baffle 18a is also capable of absorbing thermal energy from the pipe heat exchanger 11 and of releasing said thermal energy to the circulating air, in other words it may be used as an additional indirect heat exchanger component. A corresponding air baffle 18a is arranged between the lower pipe heat exchanger 12 and the lower retaining plate 17.

An upper conveyor run 19 of an endless conveyor belt 20 runs between the two pipe heat exchangers 11, 12, said upper conveyor run 19 being used to convey the bakery products through the respective conveyor baking space 7, 8 between the loading module 4 and the discharge module 5. In accordance with its two-level design, the conveyor baking oven 1 has two endless conveyor belts 20, namely an upper endless conveyor belt 20 for the baking oven modules 2ᵢ, and a lower endless conveyor belt 20 configured in the same way for the lower oven modules 3ᵢ. Therefore, it is sufficient to describe one of these conveyor belts in the following sections.

The conveyor belt 20 has a plurality of belt links 21 of which an upper belt link 21ₒ and a lower belt link 21ᵤ are shown in FIG. 2. In its current operating position, the upper belt link 21ₒ is part of the upper conveyor run 19 and is arranged in the baking space 10. The lower belt link 21ᵤ is part of a lower belt run 22, which is part of the endless conveyor belt 20 running through a return conveyor belt space 23 in a direction counter to the conveying direction 9 below the baking space 10 and the lower pipe heat exchanger 11.

Between the upper retaining plate 16 of the baking space module 18 and an upper module plate 23a of the baking oven module 2ᵢ, 3ᵢ, an upper circulating air duct 24 is arranged. Between the lower retaining plate 17 of the baking space module 18 and a lower module plate 25, a lower circulating air duct 26 is arranged. The two circulating air ducts 24, 26 extend across the entire width of the baking oven module 2ᵢ, 3ᵢ.

The two circulating air ducts 24, 26 are in a fluidic connection, via inlet and exhaust air ducts 27, 28, 29, 30, with two axial/radial fans 31, 32 (cf. FIG. 3) that may be provided if necessary. Altogether, they produce a respective circulating air cycle in the respective oven module 2ᵢ, 3ᵢ. The baking space 10 of the respective oven module 2ᵢ, 3ᵢ. is part of this circulating air cycle. Together with the respective circulating air cycle, the fans 31 and 32, respectively, are components of a circulating air system of the conveyor baking oven 1.

If provided, the two fans 31, 32 and the inlet and exhaust air ducts 27 to 30 are mounted to vertically extending lateral frame plates 33, 34 of the baking oven module 2ᵢ, 3ᵢ.

Depending on the design of the conveyor baking oven 1 and depending on the arrangement of the respective oven module 2ᵢ, 3ᵢ along the respective conveyor baking space 7, 8, the respective oven module 2ᵢ, 3ᵢ observed has precisely two axial/radial fans 31, 32 mounted in corresponding receptacles of the lateral frame plates 33, 34 in a mutually opposing configuration. In other embodiments of the oven modules 2ᵢ, 3ᵢ, there is only precisely one of the fans 31 or 32, and instead of the other fan, which is then not provided, the receptacle provided for this purpose is then closed by a blind plate. In yet another variation of the oven module 2ᵢ, both opposing receptacles are provided with respective blind plates, in other words this variation of the oven modules 2ᵢ, 3ᵢ is not equipped with any own fans, as shown in the illustration according to FIG. 2. If the respective oven module 2ᵢ, 3ᵢ does not have a fan 31 or 32, respectively, the inlet/exhaust air ducts 27, 29 on the one hand and 28, 30 on the other are in a direct fluidic connection via overflow connections 33, 34 to form the respective circulating air cycle.

When a baking operation is carried out using the tunnel conveyor baking oven 1, the bakery products passed through the oven modules 2ᵢ, 3ᵢ along the conveyor run 19 is heated, on the one hand, by radiant heat emitted by the pipe heat exchangers 11, 12 housed in the respective oven modules 2ᵢ, 3ᵢ and by the circulating air, on the other hand, which flows through the respective baking space 10 of the oven module 2ᵢ to 3ᵢ. The heat contributions “radiant heat” on the one hand and “circulating air heat” (release of heat to fluid flowing through the system) on the other can be defined by a corresponding design of the pipe heat exchangers 11, 12 and by the temperature and the flow rate of a heat carrier fluid flowing through the pipe heat exchangers 11, 12, and by the amount of air flowing through the respective baking spaces 10.

Depending on the design of the oven module 2ᵢ to 3ᵢ, an airflow through the respective baking space 10 (cf. the airflow 40 in FIG. 3, for example) can be directed from bottom to top or, alternatively, from top to bottom. If the airflow is not generated by the fans 31, 32 but by convection, the airflow through the respective baking space 10 is directed from bottom to top.

In the example of the flow shown in FIG. 3, the fan 31 on the left-hand side of FIG. 3 ensures that the circulating air entering via the inlet air duct 27 flows into the lower circulating air duct 26 first. At the same time, the fan 32 on the right-hand side of FIG. 3 ensures that the circulating air enters the lower circulating air duct 26 via the right-hand inlet air duct 28. The overpressure generated in the lower circulating air duct 26 causes the circulating air to flow from the lower circulating air duct 26 to the top, and while doing so, to pass through adjacent pipe sections of the lower pipe heat exchanger 12. The circulating air then flows through the upper conveyor run 19 of the endless conveyor belt 20 where it then flows around the dough pieces conveyed through the baking space 10 on said endless conveyor belt 20. The circulating air then flows through the gaps between pipe sections of the upper pipe heat exchanger 11 before flowing into the upper circulating air duct 24 from which the circulating air is then extracted again by the fans 31, 32 and the exhaust air ducts 29, 30 to close the respective circulating air cycle. An overpressure in the circulating air cycle is able to escape via a flap-controlled exhaust gas pipe 5 (cf. FIG. 3).

As an alternative or in addition thereto, the flow direction of the circulating air through the baking space 10 can be defined by correspondingly operating the respective fan 31, 32 from bottom to top or from top to bottom.

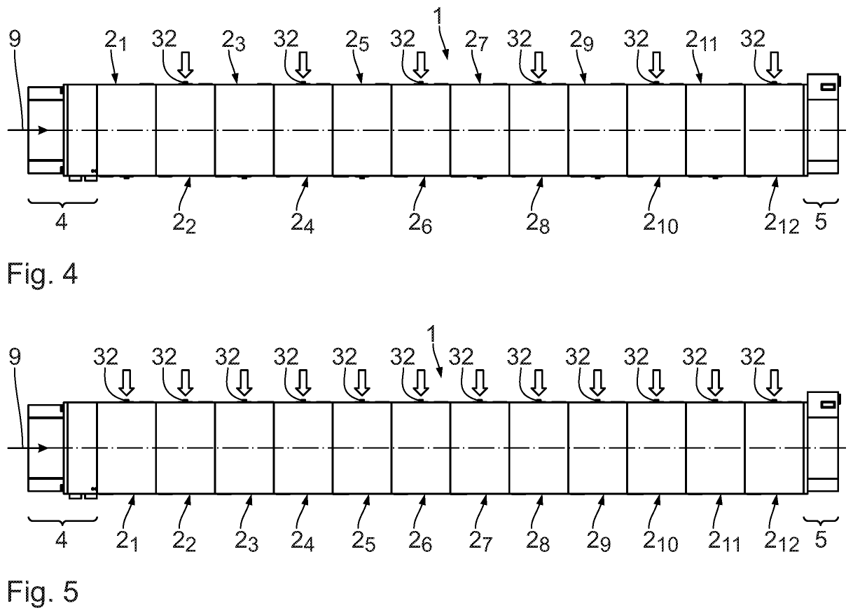

FIGS. 4 to 7 show examples of corresponding arrangements of the fans 31, 32. These arrangements are shown as examples of an embodiment of the conveyor baking oven 1 comprising twelve oven modules 2₁ to 2₁₂, 3₁ to 3₁₂. FIGS. 4 to 7 each show the upper oven modules 2₁ to 2₁₂ the respective fan variations of which will also be described below.

FIG. 4 shows an arrangement in which fans 32 are arranged on a respective side of the oven modules 2ᵢ when seen in the conveying direction 9; in the exemplary embodiment shown, fans 32 are arranged on the left-hand side of the baking spaces 10 of the oven modules 2ᵢ when seen in conveying direction 9. The fans ₃2 are arranged on every second oven module 2₂, 2₄, 2₆, 2₈, 2₁₀ and 2₁₂. The other, odd-numbered oven modules arranged in the conveying direction do not have a fan 31/32.

As an alternative to the embodiment as shown in FIG. 4, it is conceivable as well that two or even more oven modules 2ᵢ/3ᵢ arranged one behind the other are not provided with a fan.

FIG. 5 shows a variation of the one-sided arrangement, again taking the example of the arrangement of the fans 32 according to which all oven modules 2ᵢ are equipped with precisely one fan 32.

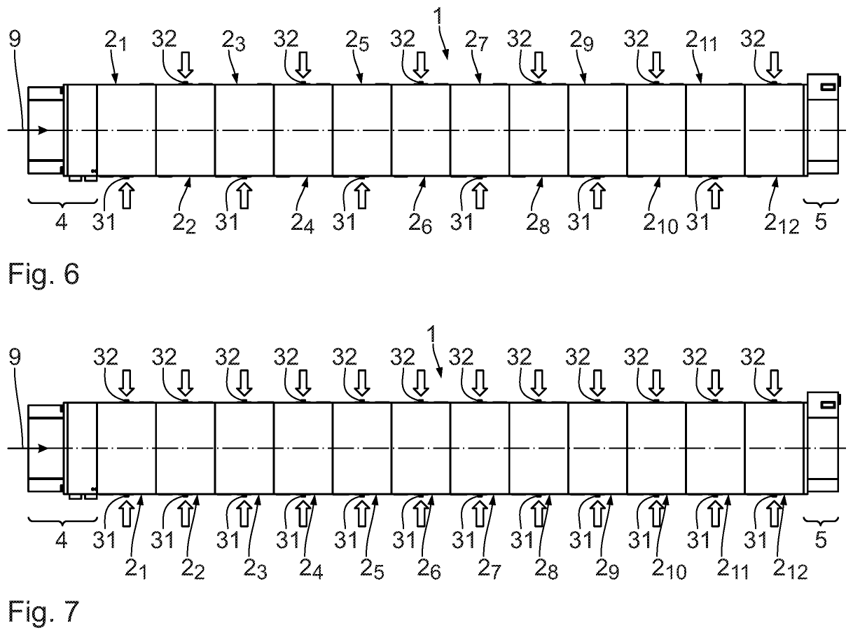

FIG. 6 shows an arrangement where the fans 31, 32 are arranged on one side and on the other side of the baking spaces of the oven modules 2ᵢ in an alternating manner. In other words, every second oven module 2ᵢ has a fan 31, arranged in each case on the right-hand side of the baking spaces 10 when seen in the baking direction 9, while the other oven modules 2ᵢ have a fan 32 arranged opposite thereto.

An alternating fan arrangement corresponding to that shown in FIG. 6 can also be configured such that a particular number of oven modules 2ᵢ/3ᵢ have the fans on the same side, and after two or more oven modules 2ᵢ/3ᵢ of this type, the fans are then arranged on the other side.

In the fan arrangement as shown in FIG. 7, each of the oven modules 2i has two opposing fans 31, 32.

The conveyor baking oven 1 is designed for the continuous baking operation. It is therefore conceivable to bake the bakery products in a continuous flow between the loading module 4 and the discharge module 5. Depending on the required bakery product throughput, it is conceivable to operate both conveyor baking spaces 7, 8 at once; alternatively, it is conceivable to optionally use only one of the two conveyor baking spaces 7 or 8. Corresponding to the continuous passage through the conveyor baking spaces 7, 8, there is a continuous loading of the conveyor baking spaces 7, 8 by the loading module 4 and a continuous discharge from the conveyor baking spaces 7, 9 by the discharge module 5.

It is conceivable to define various temperature zones in the oven modules 2ᵢ/3_{i.} This is possible by defining the temperature and/or the flow rate of the thermal oil and/or the amount of circulating air and by defining the circulating air direction from bottom to top/from top to bottom. This is done using a central control unit of the baking oven 1. This central control unit also allows one to select the fans to be operated. The fan arrangements described above with reference to FIGS. 4 to 6 can be implemented in practical application by selecting a corresponding number of active fans from the fully equipped system shown in FIG. 7. Depending on the baking requirements, a targeted baking operation with a small contribution of convective heat can be carried out by correspondingly reducing the number of active fans. The central control unit also allows operation of a delivery unit of the thermal oil heating device, which is not shown.

What is claimed is:

1. A conveyor baking oven for continuous baking operation,
with at least two conveyor baking spaces,
with a plurality of oven modules with baking spaces, which combine to form the conveyor baking spaces between a respective initial oven module arranged in a leading manner when seen in the bakery product conveying direction, and a respective final oven module, which is the last in row when seen in the bakery product conveying direction,
wherein the oven modules have a multi-level arrangement such as to define the at least two conveyor baking spaces arranged on top of one another,
with a bakery product conveyor device configured to continuously convey bakery products between the respective initial oven module and the respective final oven module of one of the conveyor baking spaces,
with a thermal oil heating device having at least one thermal oil heat exchanger configured to heat the conveyor baking spaces by radiant heat.

2. The baking oven as claimed in claim 1, wherein at least some of the oven modules have a same basic design.

3. The baking oven as claimed in claim 1, comprising a convection device configured to guide circulating air through the baking spaces in at least one circulating air cycle, with the at least one thermal oil heat exchanger being part of the at least one circulating air cycle.

4. The baking oven as claimed in claim 3, wherein at least some of the oven modules each have at least two receptacles for in each case one fan configured to circulate the circulating air, with the respective baking space of the oven module being arranged between the receptacles, with the convection device having an arrangement of fans, used to circulate the circulating air, such that at least some of the baking oven modules are each equipped with at least one fan.

5. The baking oven as claimed in claim 4, wherein the convection device has an arrangement of the fans such that all of the oven modules of a conveyor baking space are equipped with at least one fan.

6. The baking oven as claimed in claim 4, wherein the convection device has an arrangement of the fans such that the fans are arranged on the same side of the baking spaces of the oven modules of one of the conveyor baking spaces.

7. The baking oven as claimed in claim 4, wherein the convection device has an arrangement of the fans such that the fans are alternatingly arranged on one side and on the other side of the baking spaces of the oven modules of one of the conveyor baking spaces.
